(19) United States
(12) Patent Application Publication
(10) Pub. No.: US 2006/0198723 A1
(43) Pub. Date: Sep. 7, 2006

(54) Handling device for long goods

(75) Inventors: Armin Stolzer, Nierstein (DE); Valentin Meier, Appenweier (DE)

Correspondence Address: VOLPE AND KOENIG, P.C., UNITED PLAZA, SUITE 1600, 30 SOUTH 17TH STREET, PHILADELPHIA, PA, 19103, US

(73) Assignees: KEURO Besitz GmbH & Co., Achern (DE); EDV-Dienstleistungs KG

(21) Appl. No.: 11/355,798

(22) Filed: Feb. 16, 2006

(30) Foreign Application Priority Data
Mar. 3, 2005 (DE) 10 2005 009 732.4

(51) Int. Cl. B65G 47/90

(52) U.S. Cl. 414/626

(57) ABSTRACT

A handling device for long goods is provided, having a spreader beam that can be displaced at least in the vertical and the horizontal direction with load receiving devices. The load receiving devices each include a gripping device with a pair of gripper arms for engaging the long goods. Additionally, the load receiving devices are supported for pivotal movement around a horizontal rotary axis

### BACKGROUND

The invention relates to a handling device for long goods, in particular for separating and/or individually transporting rod-shaped material, comprising a spreader beam that can be displaced at least in the vertical and the horizontal direction with at least two load receiving means arranged side-by-side on the same horizontal plane.

In prior art, for example from DE-A-43 35 334, a handling device is known in the form of an exchange device, which comprises a spreader beam having fork arms extending in the horizontal direction. With the help of said fork arms it is possible to separate and/or to individually transport rod-shaped material located in the horizontal shelf spaces. Through the fork arms extending on both sides of the spreader beam, the handling device is capable of approaching shelves positioned at both sides of an aisle left for the handling device, in order to subsequently, for example, move any rod-shaped material for further processing out of the shelves to a saw-mill comprising, for example, a cold circular saw.

The handling devices known are certainly well proven and operate optimally if the rod-shaped material is provided with regular cross-sections and suitable for being stored in horizontal storage spaces.

### SUMMARY

Considering these conditions, the present invention in based on the objective of providing a handling device of the type mentioned at the outset with increased potential applications and an improved transportation behavior.

This objective is attained according to the invention in that the load receiving means each comprise a gripping device with a pair of gripper arms for engaging the long goods and that the load receiving means are at least indirectly supported pivotally around a horizontal rotary axis.

This results in the advantage that the pair of gripper arms can encircle the rod-shaped material to be manipulated during the transportation in a form and force-fitting manner, therefore, in the following they are primarily referred to as “clamps”, without this inferring any limitation, and therefore much faster drive-motions can be realized than for long goods, which are only supported loosely on horizontal fork arms. Primarily it is possible in a particularly advantageous manner for the long goods to be removed and/or stored in shelf spaces open and extending in the horizontal direction, but the very same handling device with the same spreader beam and the same load-bearing means can be adjusted by pivoting around the horizontal axis such that the long goods can also be stored in and/or be removed from storage spaces extending in the vertical direction. For this purpose the spreader beam with the pair of gripper arms is inserted from the top downwards into a vertical storage shelf open towards the top, until it laterally overlaps the long goods to be manipulated, then the pair of gripper arms are moved towards each another, clamping the long goods, and subsequently the long goods can be removed from the vertical shelf and be transported to another position, if necessary, performing a horizontal pivotal motion, for example, when the transported long goods are to be stored in a horizontal storage space.

Although a handling device for a vertical separation, i.e. manipulation of long goods from the top, is known from CH-A-668 955, with the spreader beam used here also being provided with several pairs of gripper arms. However, these pairs of gripper arms have a fixed, predetermined vertical orientation and merely allow a repositioning of the storage goods into/from storage spaces accessible from the top; additionally, due to the separation the storage goods are limited to symmetrical, preferably closed cross-sections and profiles. Here, no combination with horizontal load receiving means is disclosed, nor is it possible in this known storage arrangement to embody the load receiving means in a pivotal manner. Therefore, all storage spaces described in this example of prior art are exclusively oriented in the vertical direction and accessible only from the top.

In reference to the known spreader beams, the present invention is not limited in the load receiving means being provided for horizontal storage spaces; rather it combines vertical and horizontal repositioning processes in the same spreader beam, which is arranged for pivoting by at least 90° around a horizontal axis. Due to the pivotal spreader beam, commercial, laterally open cassettes with cantilever-type storage spaces oriented in the horizontal or vertical direction, which are fixed or variable, can be retrofitted. The pivotal spreader beam can store and/or remove the long goods both into/out of cassettes from the top as well as laterally into/out of cassettes provided with cantilevers. For this purpose, the “retrofitted cantilever spaces” are beneficially determined by interlocking connections at the upper sides of the mentioned commercial cassettes in the interlocking recesses to be provided there.

Overall, the handling device according to the invention therefore manipulates the long goods with at least two translating and one rotary degrees of freedom, by which a considerable improvement results in reference to conventionally known handling devices, not only with regard to the storage possibilities (by additional vertical storage spaces) but also with regard to the manipulating speed (by way of a secured transportation of the clamped, rod-shaped objects).

In this context, it is particularly advantageous for the load receiving means to be provided with a pivotal range of at least 90° and, in particular of 1800, in order to allow not only a horizontal repositioning in a horizontal direction and a vertical repositioning, but also to allow a horizontal repositioning into the other horizontal direction and therefore, for example the storage in horizontal storage spaces along both sides of a single aisle. For example, if long goods are to be removed from one side of the aisle of the shelf and to be stored in the opposite side, this could include that the spreader beam with the pair of gripper arms oriented in the horizontal direction enters the shelf aisle from the top, subsequently approaches the shelf horizontally, grabs the rod-shaped material, withdraws from the shelf, is displaced upwards out of the shelf aisle in order to perform a pivotal motion of 180°, and then the spreader beam again inserts into the aisle with pairs of gripper arms oriented in the opposite direction, and the long goods is stored in the opposite shelf space.

With regard to the pivotability of the load receiving means, it is possible, on the one hand, for the load receiving means to be arranged pivotally on the spreader beam. Additionally, it is also possible to arrange the spreader beam itself pivotally in the handling device and, in particular, pivotally at a lifting sled, which can be displaced in the vertical direction.

Another advantage results when the spreader beam is provided double or multiply divided, in order to transport shorter long goods with the section of the spreader beam corresponding to its length. Here, the second section of the spreader beam could either be pivoted away entirely in the opposite direction; however, it would be sufficient if the second, inactive section of the spreader beam and/or at least the lower grasping arm were pivoted slightly downwards by a few degrees, so that when the gripper arms enter a shelf space and during a subsequent slight raising of the gripper arms allocated to the inactive spreader beam were arranged low enough as to not lift any potentially present material and therefore leave empty when the spreader beam is removed. Such a slight displacement downwards can advantageously be realized via a cam lever.

By dividing the spreader beam, it is possible to store shorter rod-shaped material in the same shelf space, aligned towards one another and axially behind one another, and to manipulate them independent from one another.

In this context, it is certainly advantageous if the load receiving means of the two spreader beam sections can be operated independent from one another, i.e. can perform a grasping and/or clamping motion independent from one another, in order to avoid accidentally engaging other rod material by the non-engaging pair of gripper arms when repositioning shorter rod material.

In order to securely hold the long goods and to protect them during transportation from sagging and furthermore in order to distribute the clamping forces to many contact areas it is recommended for the spreader beam to be provided with a multitude of load receiving means, for example, for stiff rods at least two, for sagging, soft rods several gripping fork arms.

Furthermore, the speed of manipulation for the manipulation device according to the invention can be increased even further in that the pair of gripper arms being embodied with such a length that multiple manipulation is possible, i.e. several rod-shaped materials can be simultaneously clamped and stored and/or removed.

Another possibility for improving manipulation results when the pair of gripper arms can be addressed and operated individually and separately from one another.

Overall, it is possible with the manipulation device according to the invention to reposition individual rods from single-layer into multi-layer shelves or cantilever-type cassettes and/or vice versa, to separate individual rods for transportation to further processing arrangements (in particular to a sawmill), or to separate individual or several rods in order to form commissions of long goods.

### BRIEF DESCRIPTION OF THE DRAWINGS

Additional features and advantages of the present invention are disclosed in the sub-claims and discernible from the following description of an exemplary embodiment. In the drawings:

FIG. 1 is a front view of a handling device according to the invention;

FIG. 2 is a front view of a spreader beam of a handling device according to the invention in various pivotal positions a), b), c), d);

FIGS. 3a and 3b is a side view of the spreader beam of a handling device according to the invention shown in two phases of a grasping motion;

FIG. 4a is a front perspective views of a spreader beam storing rod-shaped material in a horizontal cantilever-type cassette from the left side;

FIG. 4b is a side view of the spreader beam of FIG. 4a;

FIG. 5a is a perspective view of a spreader beam according to FIG. 4a during the horizontal repositioning in a horizontal cantilever cassette from the left;

FIG. 5b is a side view of the spreader beam in the position in FIG. 5a

FIG. 6a is a perspective view of the spreader beam according to FIGS. 4a and 4b during the vertical repositioning;

FIG. 6b is a perspective view of the spreader beam according to FIGS. 5a and 4b during the vertical repositioning; and

FIG. 7 is a view of a cantilever-type shelf according to one aspect of the invention that can be retrofitted.

### DETAILED DESCRIPTION OF THE PREFERRED EMBODIMENTS

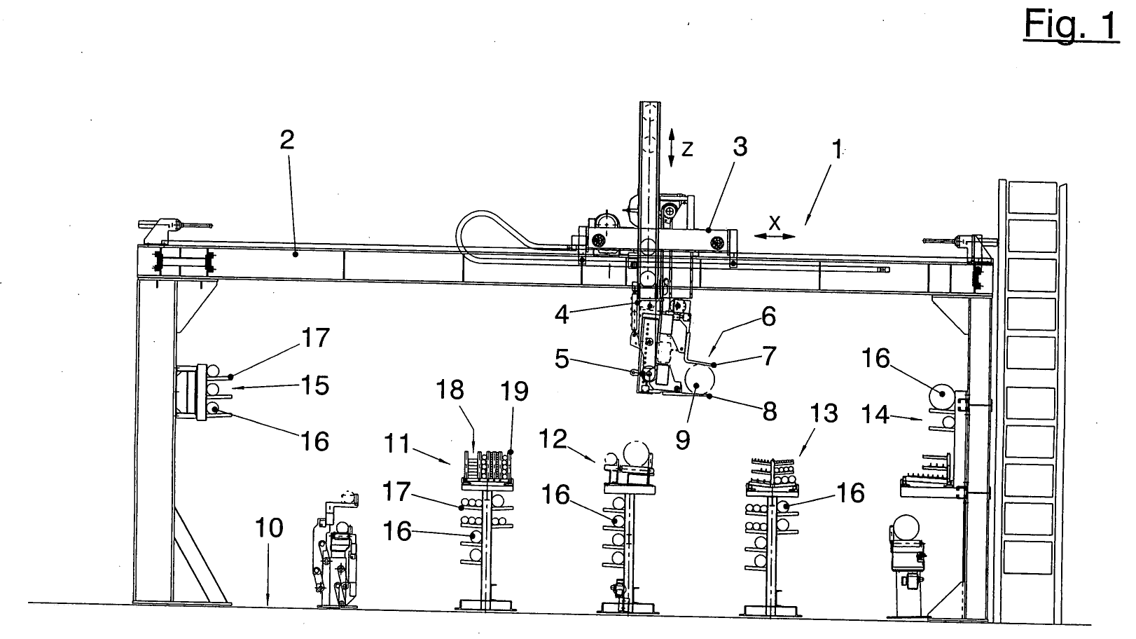

FIG. 1 shows a handling device 1 with a horizontal sled 3 that can be displaced on a gantry spreader beam 2 extending in the horizontal direction and a lifting sled 4 that can be displaced in the vertical direction on the horizontal sled 3. Through use of the horizontal sled 3 and the lifting sled 4, two translating degrees of freedom result for the handling device, namely in the horizontal X-direction and the vertical Z-direction.

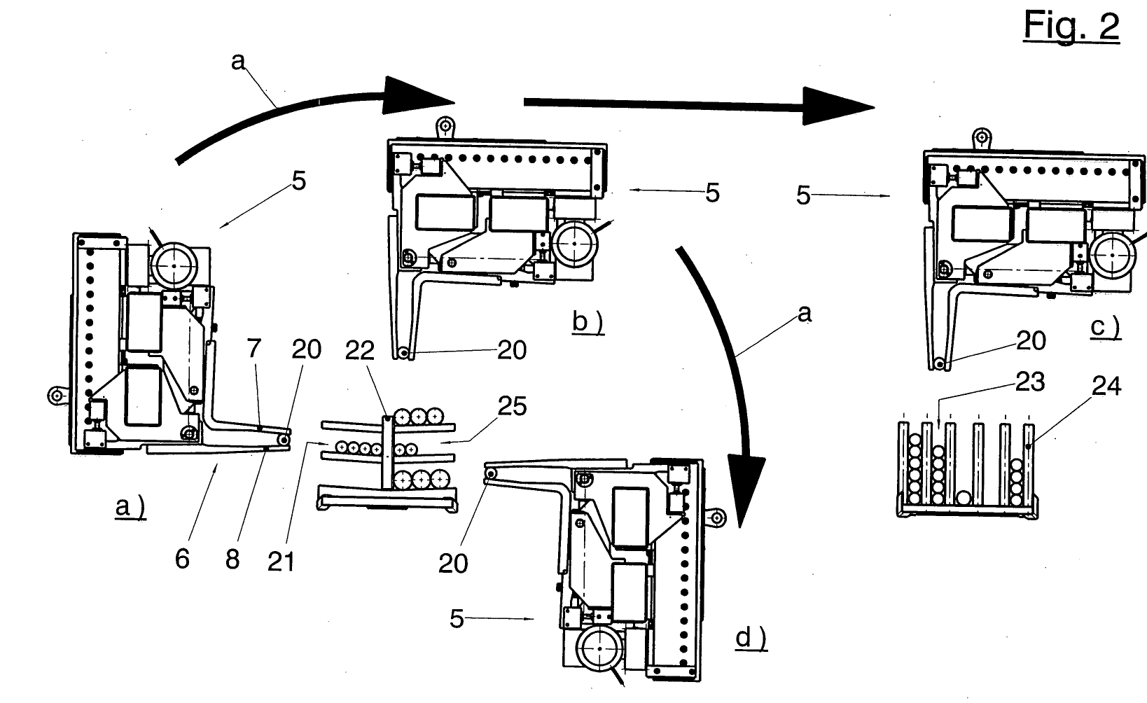

On the lifting sled 4, a lifting beam 5 is provided extending in the horizontal direction, which is shown in greater detail in the FIGS. 2 through 6. The lifting beam 5 is provided with a multitude of load receiving means 6 in the form of gripper arms 7, 8 provided in pairs, which clamp the rod-shaped material 9 between themselves in the representation according to FIG. 1.

In FIG. 1, on a hall floor 10, exemplary cantilever-type cassettes and/or shelves 11, 12 13, 14, 15, are shown, in which rod-shaped long goods 16 are stored having various diameters and various cross-sections, waiting for further processing. While most of the shelves are provided with horizontal boards with horizontal cantilever-type arms 17, a vertical storage is provided on the upper side of a shelf 11, which comprises vertical dividers 19 forming a multitude of vertical spaces 18.

It is easily discernible that the rod-shaped material provided here cannot be stored and/or removed by conventional horizontal fork arms.

FIG. 2 shows a lifting beam 5 with the two exemplary fork arms 7, 8, which combined form a load receiving means 6. The fork arms 7, 8 clamp a rod 20 between each other, which they have removed from a horizontal storage space 21 of a horizontal storage 22. Based on the representation according to FIG. 2a, the spreader beam is pivoted by 90° in the clock-wise direction, according to an arrow a, symbolizing the horizontal pivot axis movement, into the position according to FIG. 2b, where the gripper arms 7, 8, which essentially extend in the horizontal direction in FIG. 2a are now oriented in the vertical direction. From this position, the spreader beam can either be displaced further in the horizontal direction into the position according to FIG. 2c, in order to subsequently store the rod 20 in a vertical storage space 23 of a vertical storage 24 from the top; or the spreader beam is further rotated by another 90° in the clock-wise direction into the position according to 2d), in order to store the rod 20 from the right side towards the opposite side of the horizontal storage space 22 in a horizontal storage shelf 25.

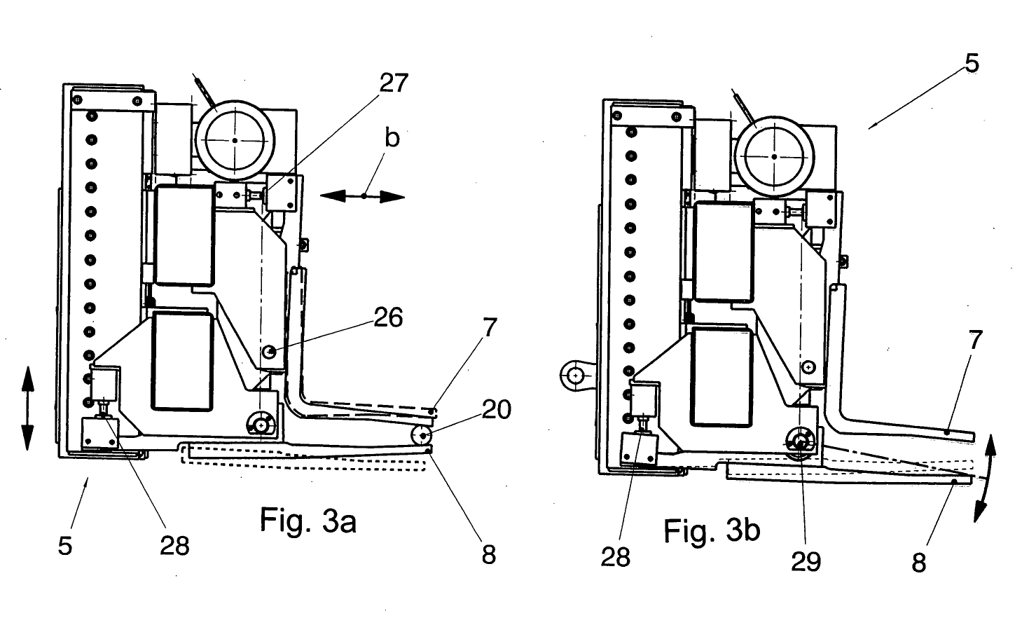

In FIG. 3a, the grasping motion of the gripper arms 7, 8 is shown from an original position, shown in dot-dash lines, into the position shown in continuous lines, in which the rod 20 is engaged from the top and the bottom and in this way is clamped between the two gripper arms. This approaching motion of the gripper arms occurs around a drag-hinge 26, with an actuator 27 moving the free end 7a of the grasping arm 7 in the direction of the arrow b and this way effects the opening and/or closing motion of the pair of gripper arms.

According to FIG. 3b, the lower grasping arm 8 can be rotated around a pivotal bearing 29 downwards by another actuator 28, in order to, on the one hand, support the grasping motion, and, on the other hand, deactivate said pair of gripper arms. By the downwards rotation, the situation can be avoided that the lower gripper arms engage any rod material potentially present in the storage space when repositioning.

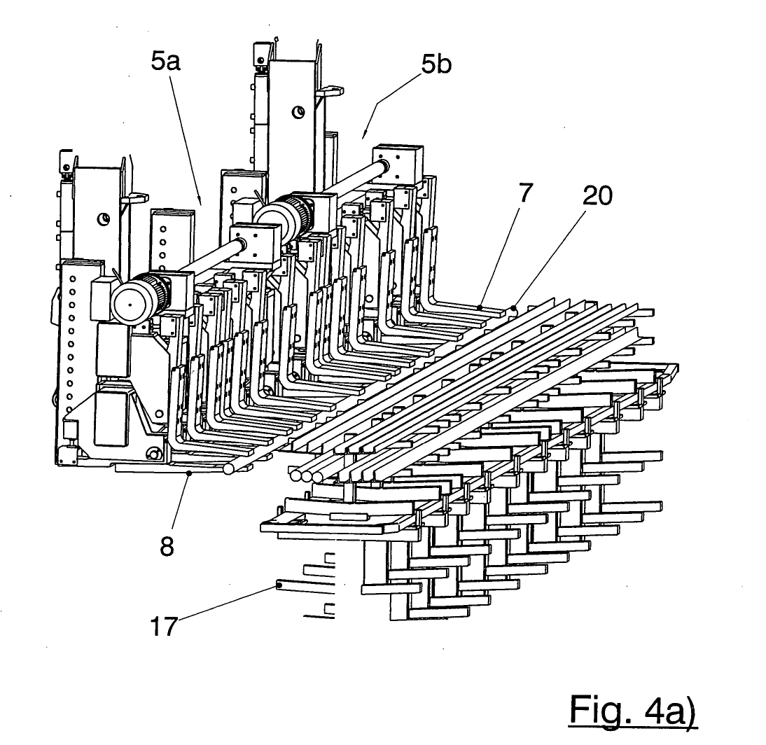

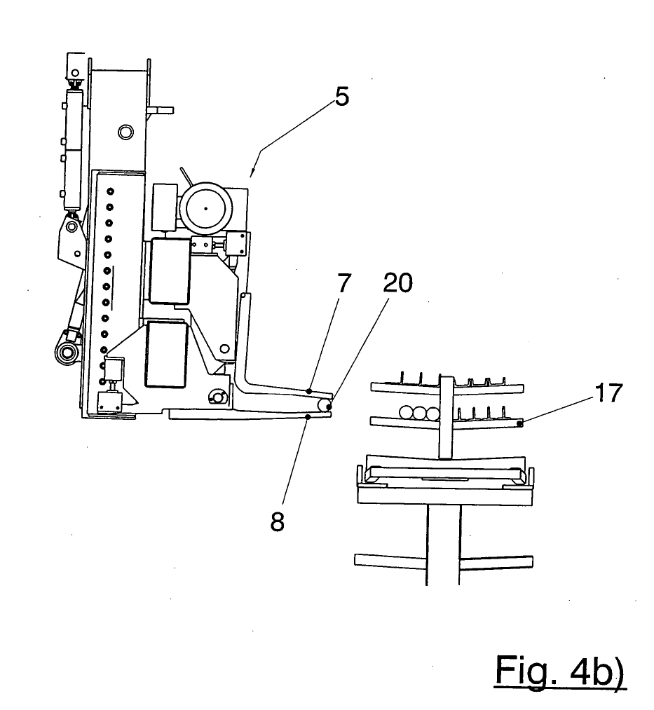

FIG. 4a and FIG. 4b show views at the same position according to FIG. 2a, when removing the rod-shaped material 20. Here it is also understood that the horizontal arms 17 and the pair or gripper arms 6 are arranged off-set in reference to one another such that they cannot collide. Furthermore, the gripper arms are provided such that their dimensions are not any thicker than the horizontal arms in order to be able to insert them into the intermediate space between neighboring horizontal arms without simultaneously accidentally engaging any rod-shaped material arranged above or below it. In FIG. 4a it is also discernible that the spreader beam 5 is divided into two tie-bar sections 5a, and 5b, which can operate independent from one another and, this way, for example, serve to reposition short rod-shaped material.

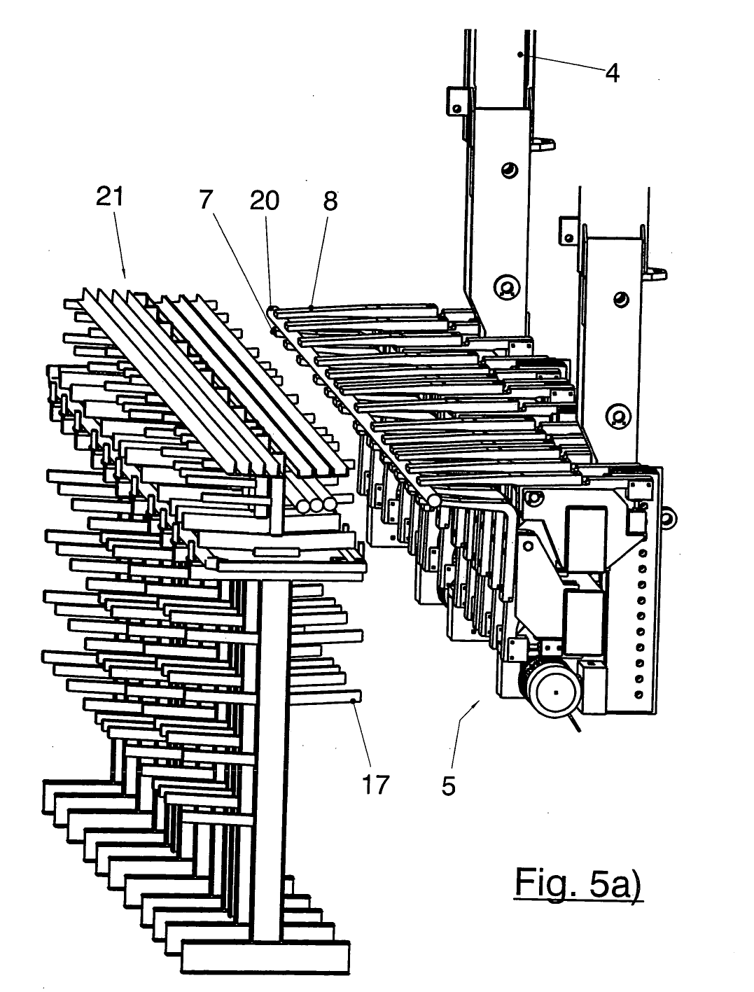

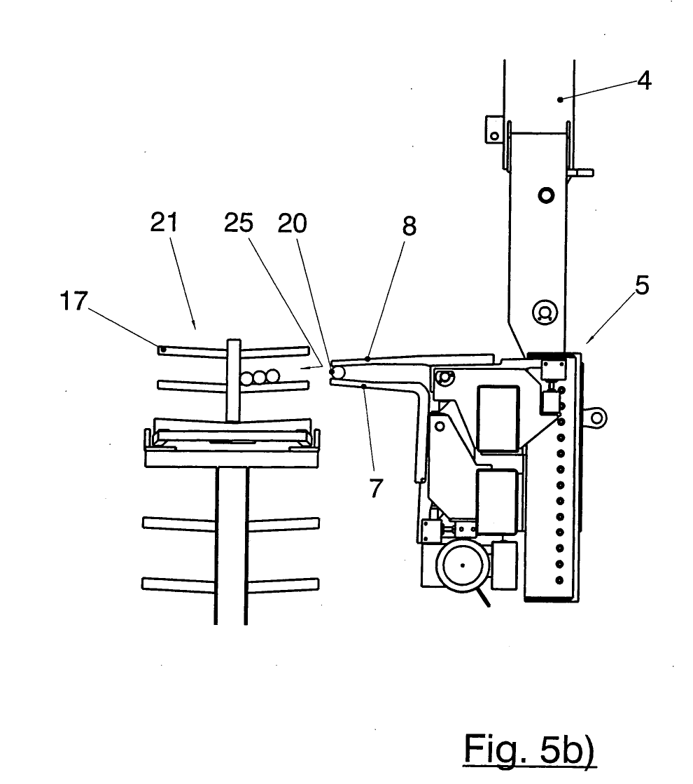

FIGS. 5a and 5b show the position according to FIG. 2d, in which the spreader beam is pivoted by 180° in reference to the position according to FIG. 4a and 4b, in order to store the rod 20 from the right side into the horizontal storage space 25 of the horizontal storage 21.

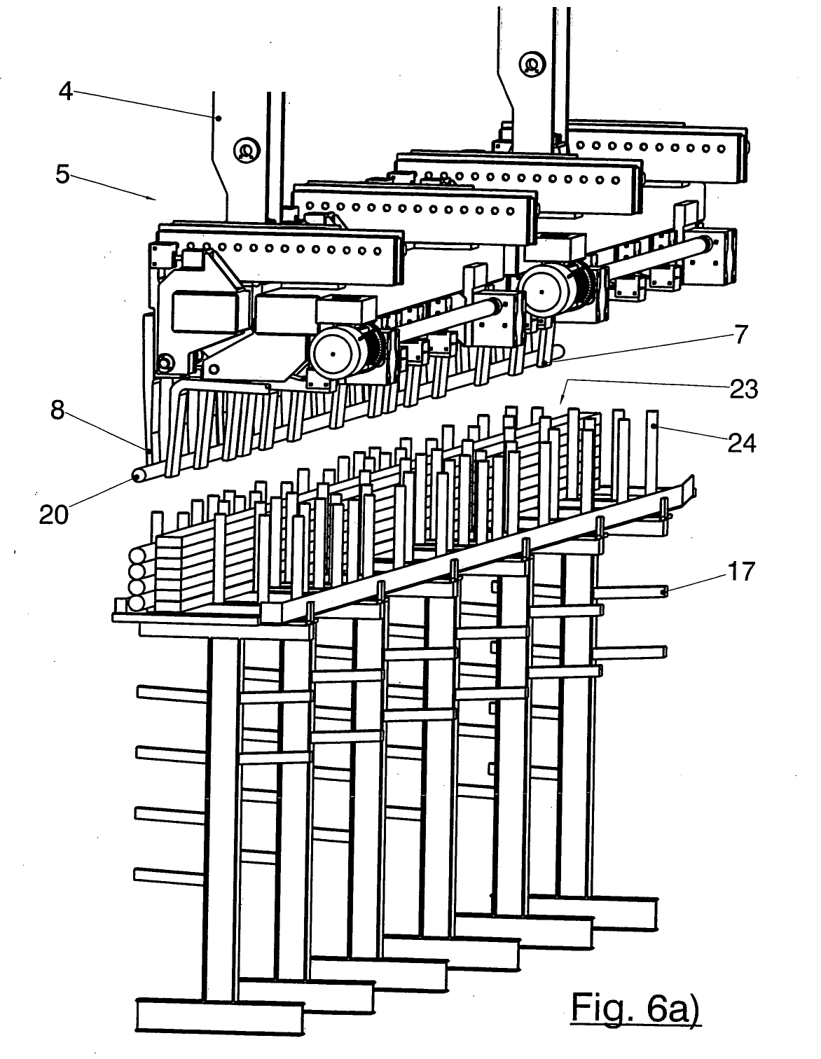

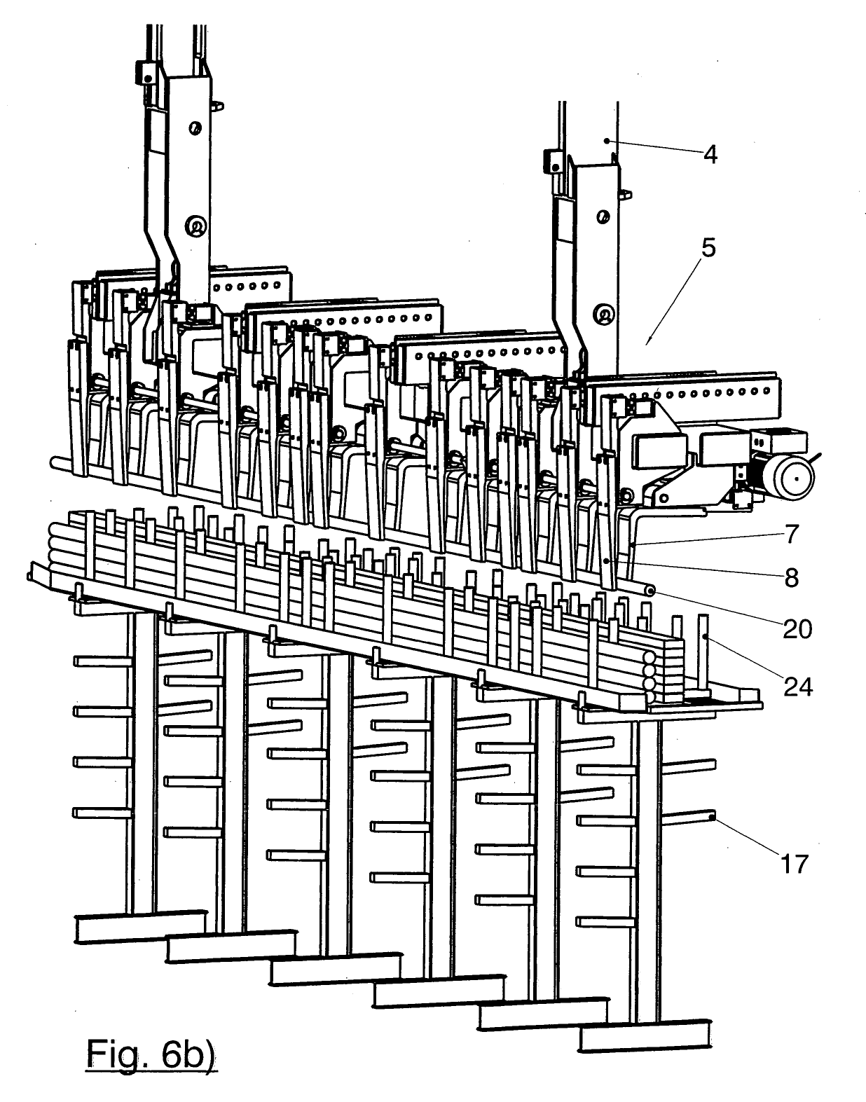

Finally, FIGS. 6a and 6b show a position of the spreader beam 5 according to FIG. 2c, namely when vertically storing the rod 20 from the top into a vertical storage space 23 of the vertical storage 24.

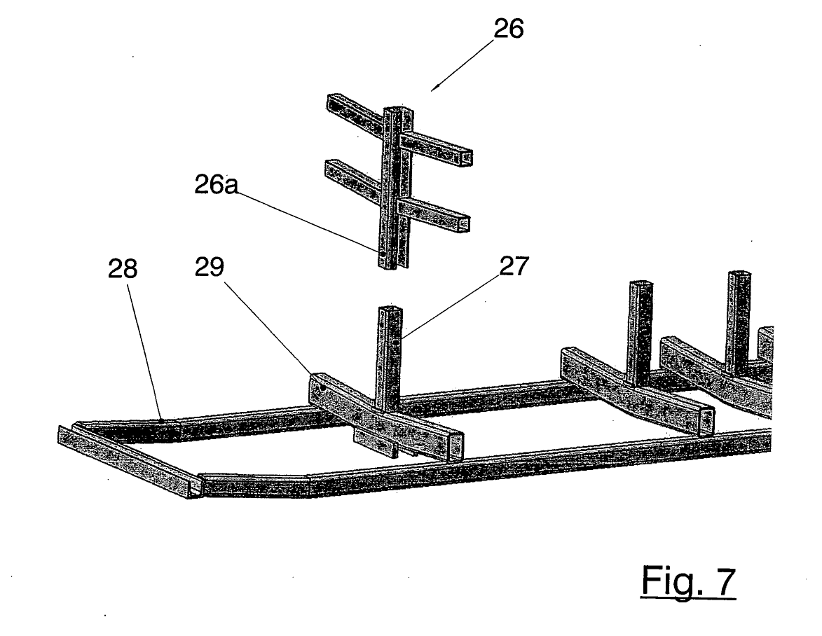

Finally, in FIG. 7 a cantilever-like shelf 26 is shown, which can be retrofitted, which cooperates with an interlocking recess 27 of a cassette 28 via an interlocking connection (the vertical rod 26a is provided as hollow). When necessary, it is therefore possible to provide horizontal cantilever-like spaces on the cassette, which can be separated due to the separation capability of the interlocking connection. Without said cantilever-like spaces the long goods can be stored on horizontal connection rods 29, carrying the interlocking recess.

Concluding, the present invention offers the advantage to allow the approach of both horizontal and vertical storage spaces using the same spreader beam and this way allows a greater variety in storage and material. Furthermore, by the clamping of the material to be manipulated a certain transportation safety is achieved, which in turn causes the transportation speed to increase considerably.

1. A handling device for long goods (8, 16, 20), adapted for separating and/or individually transporting rod-shaped material, comprising a spreader beam (5) which is at least displaceable in the vertical and the horizontal direction, at least two load receiving means (6) arranged side-by-side in a horizontal plane, the load receiving means (6) each comprise a gripping device with a pair of gripper arms (7, 8) for engaging the long goods, and the load receiving means being supported for pivotal movement around a horizontal rotary axis (a).

2. The handling device according to claim 1, wherein the load receiving means (6) are provided with a pivoting range of at least 90°.

3. The handling device according to claim 1, wherein the spreader beam (5) is arranged pivotally in the handling device (1) on a lifting sled (4) that is displaceable in the vertical direction.

4. The handling device according to claim 1, wherein the load-receiving means (6) are arranged pivotally on the spreader beam (5).

5. The handling device according to claim 1, wherein the pair of gripper arms (7, 8) clamps the long goods (8, 16, 20) between themselves.

6. The handling device according to claim 1, wherein the spreader beam (5) comprises at least in two sections.

7. The handling device according to claim 6, wherein the load-receiving means (6) of the sections (5a, 5b) of the spreader beam can be operated independent from one another.

8. The handling device according to claim 1, wherein the gripper arms (7, 8) of the load receiving means (6) are generally arranged parallel in reference to one another.

9. The handling device according to claim 8, wherein the gripper arms (7, 8) can be pivoted from a first horizontal position through a vertical position and into a second horizontal orientation.

10. The handling device according to claim 8, wherein the gripper arms (7, 8) can be oriented in the vertical direction, in order to manipulate long goods in the vertical direction from a top position.

11. The handling device according to claim 8, wherein the gripper arms (7, 8) can be oriented in the horizontal direction, in order to manipulate long goods in the horizontal direction from a side position.

12. The manipulation device according to claim 1, wherein the spreader beam (5) is provided with a multitude of load-receiving means (6).

13. The handling device according to claim 1, wherein the handling device (1) manipulates the long goods (8, 16, 20) with at least two translating and one rotary degrees of freedom.

14. The handling device according to claim 1, wherein the load receiving means (6) can be operated individually and separately from one another.

15. The handling device according to claim 1, wherein the load receiving means (6) cooperate with long goods (8, 16, 20), which are stored in cantilever-arm storage spaces (26) aligned in the horizontal or vertical direction, and the cantilever-like storage spaces (26) can be separated.

16. The handling device according to claim 2, wherein the load receiving means (6) are provided with a pivoting range of about 180°.
